(19) United States
(12) Patent Application Publication
(10) Pub. No.: US 2012/0132051 A1
(43) Pub. Date: May 31, 2012

(54) Saw Chain For Aggregate Materials

(75) Inventor: Karl H. Moller, North Palm Beach, FL (US)

(73) Assignee: Diamond Products, Limited, Elyria, OH (US)

(21) Appl. No.: 13/303,644

(22) Filed: Nov. 23, 2011

Related U.S. Application Data
(60) Provisional application No. 61/417,488, filed on Nov. 29, 2010.

(51) Int. Cl. B28D 1/08

(52) U.S. Cl. 83/830

(57) ABSTRACT

A saw chain for cutting aggregate materials comprises a plurality of identically shaped interconnected links. Each link has first and second ends configured such that a first end of one link is connected to a second end of an adjacent link of the saw chain. The first end of each link includes spaced apart tabs, and the second end of each link includes a tab. The second end tab of each link is dimensioned to be pivotally received between the first end tabs of an adjacent link. A plurality of fasteners interconnects the links, the fasteners being configured to at least partially protect the saw chain protecting the links against impacts.

The present application claims priority to U.S. Provisional Patent Application No. 61/417,488 filed on Nov. 29, 2010, which is incorporated herein in its entirety.

### BACKGROUND

Exemplary embodiments herein generally relate to a saw chain used for cutting through aggregate materials.

Conventional saw chains used for cutting aggregate material, such as hardened concrete, suffer unique wearing problems. Unlike wood cutting which primarily removes wood material in the form of chips, concrete cutting removes material by abrasion in the form of minute particles referred to as fines. A particular problem experienced by conventional saw chains are that the saw chains are constructed of numerous individual links (e.g., center/drive links and side links) pivotally connected together by pins or rivets. Each individual link of the saw chain is provided with a front and rear rivet hole. The rear hole of a center link is aligned with the front holes of a pair of following side links. The front hole of the center link is aligned with the rear holes of a pair of leading side links. Rivets projected through the aligned holes join the links together and the sequence is repeated throughout to form a desired loop of saw chain. The saw chain loop is mounted on a guide bar and drive sprocket of a saw and travels in a substantially oval path. As the individual links travel around the defined oval path, the links pivot relative to each other. One problem with the known saw chain is the wearing of the chain due to this pivoting action. Such wearing causes the saw chain to stretch to the point where the sprocket no longer properly fits between the center links causing a further wearing problem. In combination, the wearing prematurely reduces the life of the saw chain.

### BRIEF DESCRIPTION

In accordance with one aspect, a saw chain for cutting aggregate materials comprises a plurality of identically shaped interconnected links. Each link has first and second ends configured such that a first end of one link is connected to a second end of an adjacent link of the saw chain. The first end of each link includes spaced apart first tabs, and the second end of each link includes a second tab. To interconnect the plurality of links of the saw chain, the second tab of each link is pivotally received between the first tabs of an adjacent link. A plurality of cutting blocks is mounted on alternating links along a length of the saw chain for engaging and eroding away the aggregate materials. A plurality of fasteners interconnects the links, the fasteners defining pivotal axes of the saw chain.

According to another aspect, a saw chain for cutting aggregate materials comprises a plurality of identically shaped interconnected one-piece links. Each link of the plurality of links includes a body having a front surface, a rear surface, a top surface, a bottom surface and first and second side surfaces. A pair of spaced apart first tabs extend outwardly from the first surface and a second tab extends outwardly from the second surface. The first tabs and second tab are identically shaped and include an opening. When viewed from the front, each of the first tabs and the second tabs have an arcuate outer surface. To interconnect the plurality of links of the saw chain, the second tab of each link is pivotally received between the first tabs of an adjacent link. A plurality of cutting blocks is mounted on the top surface of alternating links along a length of the saw chain for engaging and eroding away the aggregate materials. A plurality of fasteners extend through the openings of the first tabs and second tabs for interconnecting the plurality of links

### BRIEF DESCRIPTION OF THE DRAWINGS

FIG. 1 is a perspective view of a section of a saw chain having a cutting block used for cutting through aggregate materials according to one exemplary aspect of the present disclosure.

FIG. 2 is a top plan view the section of the saw chain of FIG. 1.

FIG. 3 is a front view of the section of the saw chain of FIG. 1.

FIG. 4 is a rear view of the section of the saw chain of FIG. 1.

FIG. 5 is a front view one of the plurality of links of the saw chain of FIG. 1

FIG. 6 is a top plan view of the link of FIG. 5.

FIG. 7 is a left side view of the link of FIG. 5.

FIG. 8 is a right side view of the link of FIG. 5.

FIG. 9 is a cross-sectional view of the link of FIG. 5 taken generally along line 9-9 of FIG. 5.

FIG. 10 is a cross-sectional view of the link of FIG. 7 taken generally along line 10-10 of FIG. 7.

FIG. 11 is a perspective view of one of the plurality of fasteners of the saw chain of FIG. 1.

FIG. 12 is a side view of the fastener of FIG. 11.

FIG. 13 is a front view of the fastener of FIG. 11.

FIG. 14 is a right side view of the chain saw of FIG. 1 including a cutting block according to another exemplary aspect of the present disclosure.

### DETAILED DESCRIPTION

It should, of course, be understood that the description and drawings herein are merely illustrative and that various modifications and changes can be made in the structures disclosed without departing from the present disclosure. It will also be appreciated that the various identified components of the exemplary saw chain disclosed herein are merely terms of art that may vary from one manufacturer to another and should not be deemed to limit the present disclosure.

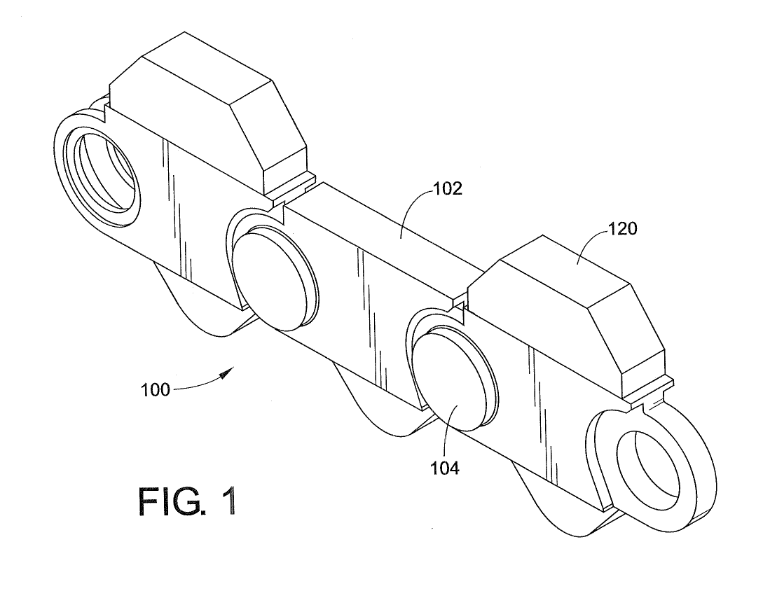

Referring now to the drawings, wherein like numerals refer to like parts throughout the several views, FIGS. 1-4 illustrate a section of an exemplary saw chain 100 for cutting aggregate material according to one aspect of the present disclosure. Aggregate materials, as the term is used herein, includes those materials that are hard and brittle. Concrete, brick, granite, marble, sandstone, limestone and the like are all examples of aggregate materials. The exemplary saw chain 100 is an articulated saw chain having a plurality of interconnected links 102. As will be discussed in greater detail below, the plurality of links 102 are identically shaped, and are pivotally joined together by fasteners 104, such as pins or rivets, to form a loop. The fasteners 104 are the pivotal axes of the links 102 of the saw chain 100 to provide the articulation necessary for the saw chain to traverse a guide bar (not shown) and drive sprocket (not shown) of an associated saw. Each of the links 102 includes a depending tang 110 that is engaged by the drive sprocket to propel the saw chain 100 around the guide bar in a conventional manner. The depending tangs 110 also fit in guide grooves of the guide bar to guide the saw chain as it is traverses around the guide bar in a conventional manner. Cutting blocks 120 are mounted on alternating links 102 along the length of the saw chain 100. The cutting blocks 120 engage and erode away the aggregate material as the saw chain 100 is propelled around the guide bar.

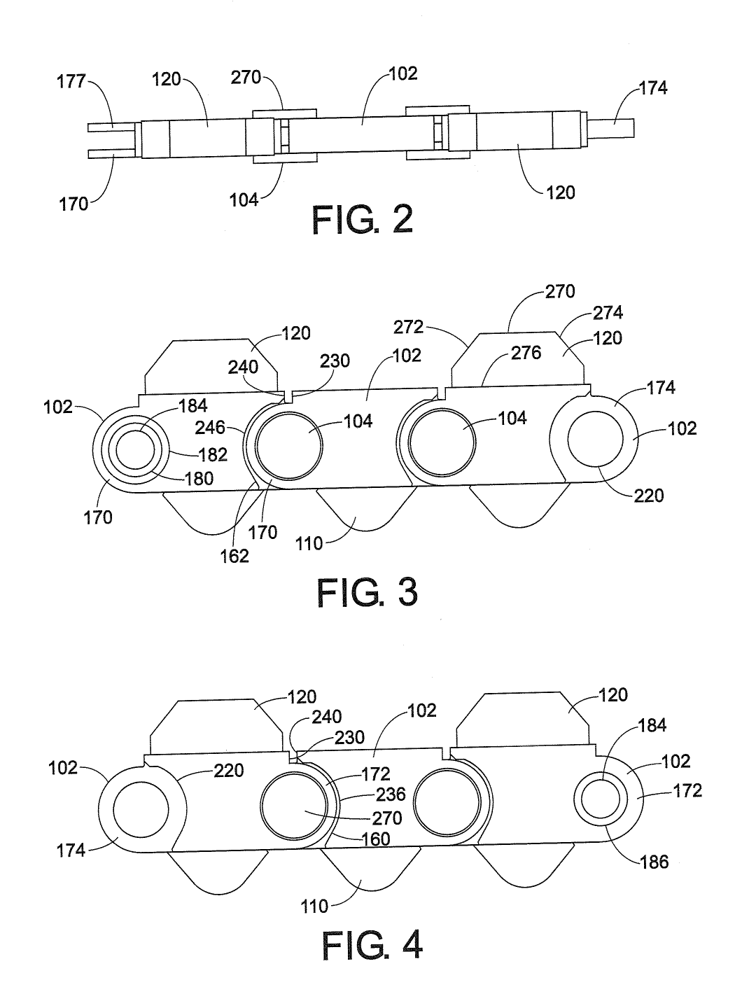

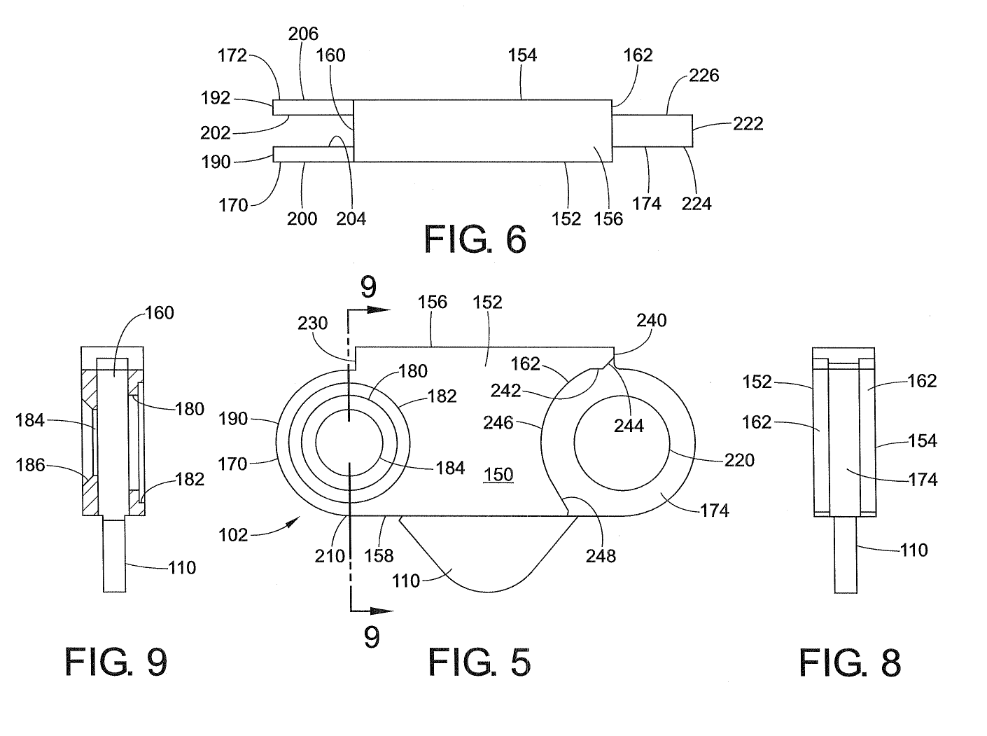

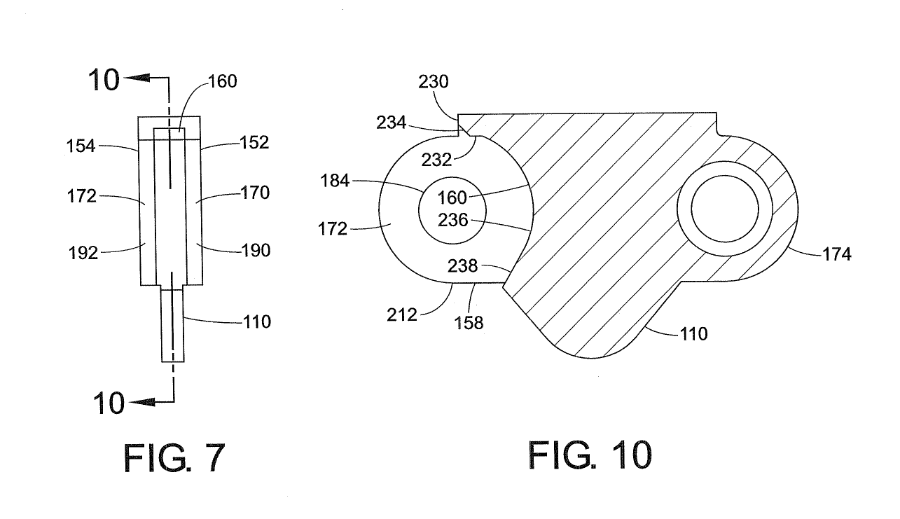

With reference to FIGS. 5-8, each link of the plurality of links 102 is a unitary, one-piece link and includes a body 150 having a front surface 152, a rear surface 154, a top surface 156, a bottom surface 158 and side surfaces 160 and 162. The tang 110 depends downwardly from a central portion of the bottom surface 158 (i.e., the tang 110 is equally spaced between the front and rear surfaces 152, 154 and is equally spaced between the side surfaces 160, 162). Extending outwardly from side surface 160 is a pair of spaced apart, identically shaped tabs 170 and 172, and extending outwardly from side surface 162 is tab 174. With reference back to FIGS. 2-4, to interconnect the plurality of links 102 of the saw chain 100, tab 174 of one link is received between tabs 170, 172 of an adjacent link and is pivotally connected to tabs 170, 172 of the adjacent link via fastener 104.

More particularly, each link 102 includes a first opening 180 having a counterbore 182 that extends through tab 170. A second opening 184 having a countersink 186 extends through tab 172. The second opening 184 is coaxial with the first opening 180 and has a diameter smaller than a diameter of the first opening 180. When viewed from the front, the second opening 184 is concentric with the first opening 180 and the counterbore 182. Each of the tabs 170, 172 also includes an outer surface 190, 192 having an arcuate shape, a front surface 200,202 and a rear surface 204,206. When viewed from the front, outer surface 190 of tab 170 is generally concentric with the first opening 180. Similarly, when viewed from the rear, outer surface 192 is generally concentric with second opening 180. In the depicted exemplary embodiment, the front surface 200 of tab 170 is contiguous with the front surface 152 of the link body 150 and the rear surface 206 of the tab 172 is contiguous with the rear surface 154 of the link body 150. An upper portion of each tab 170,172 is spaced from the top surface 156. A bottom portion of each tab 170,172 includes a planer section 210, 212 which is generally contiguous with the bottom surface 158 of the link body 150.

An opening 220 extends through tab 174. The opening 220 has a diameter substantially equal to the diameter of the first opening 180, and a center axis of the opening 220 is aligned with center axes of the first and second openings 180, 184. Particularly, the center axis defined by the opening 220 lies in the same plane as the center axes defined by the first and second openings 180, 184 of the respective tabs 170, 172. Tab 174 has shape identical to the shape of each tab 170, 172 and includes an outer surface 222 having an arcuate shape, a front surface 224 and a rear surface 226. Therefore, when viewed from the front, outer surface 222 of tab 174 is generally concentric with the opening 220. The front surface 224 is spaced inwardly from the front surface 152 of the link body 150 and the rear surface 226 is spaced inwardly of the rear surface 154 of the link body 150. With reference back to FIGS. 2-4, tab 174 of one link 102 is dimensioned to fit between the tabs 170, 172 of an adjacent interconnecting link. Specifically, a width of tab 174 is slightly smaller than the spacing between tabs 170, 172 such that tab 174 of one link can be positioned between tabs 170, 172 of another link. Once positioned between tabs 170, 172 of another link, the opening 220 is coaxial with the first and second openings 180, 184 which allows the fastener 104 to extend through the openings 180, 184, 220 thereby securing the tab 174 of the one link between the tabs 170, 172 of another adjacent link.

With particular reference to FIGS. 5 and 10, to allow for the interconnection of adjacent links 102 of the saw chain 100, the side surfaces 160, 162 are appropriately shaped which allows for pivotal movement of the plurality of links 102 as the saw chain 110 is propelled around the guide bar. As depicted, the side surface 160 is concaved toward the side surface 162 and the side surface 162 is concaved toward the side surface 160. More particularly, side surface 160 of the link body 150 is separated into a plurality of sections. A first, upper section or stop 230 extends generally perpendicularly from the top surface 156 toward the upper portions of the tabs 170, 172. A second section 232 extends generally parallel to the top surface 156 and generally tangentially to the upper portions of the outer surfaces 190, 192 of the tabs 170, 172. A beveled section 234 interconnects the first and second sections 230, 232. An arcuate section 236 extends inwardly toward the body second surface 162 and has a radius slightly larger than a radius defined by the outer surface 190, 192 of each respective tab 170, 172. As shown in FIG. 3, the arcuate section 236 is generally concentric with the outer surfaces 190,192 of the tabs 170,172. The arcuate section 236 transitions into a lower section or tangential section 238 that extends at an obtuse angle away from the bottom surface 158 of the link body toward the arcuate section 236. With this configuration of side surface 160, inner portions of the tabs 190, 192 project at least partially into the body 150. Side surface 162 is a mirror image of side surface 160. Side surface 162 includes a first section or stop 240, a second section 242, a beveled section 244 that interconnects the first and second sections 230, 232, an arcuate section 246, and a lower section or tangential section 248. As illustrated in FIGS. 3 and 4, the arcuate section 236 of one link 102 is spaced from the tab 172 of an adjacent, connected link.

The shape of each side surface 160, 162 also allows the tabs of interconnecting links 102 to extend or project at least partially into the body 150, thereby allowing for a controlled articulation of the links 102. For example, as shown in FIGS. 3 and 4, tab 170 of one link 102 projects at least partially into the body 150 of an adjacent link 102 toward side surface 162 the adjacent link, and the tab 172 of the one link projects at least partially into the body 150 of another adjacent link 102 toward side surface 160 of that link. The size of the arcuate sections 236,246 provides for a clearance between the interconnected links allowing for articulation of the links. It should be appreciated that the tangential section 238 of side surface 160 and the corresponding tangential section 248 of side surface 162 can provide for further pivotal movement of the interconnected links of the saw chain 100 as it is propelled around the guide bar. Further, the stops 230,240 can prevent flexing of the saw chain 100 in the wrong direction, away from the guide bar.

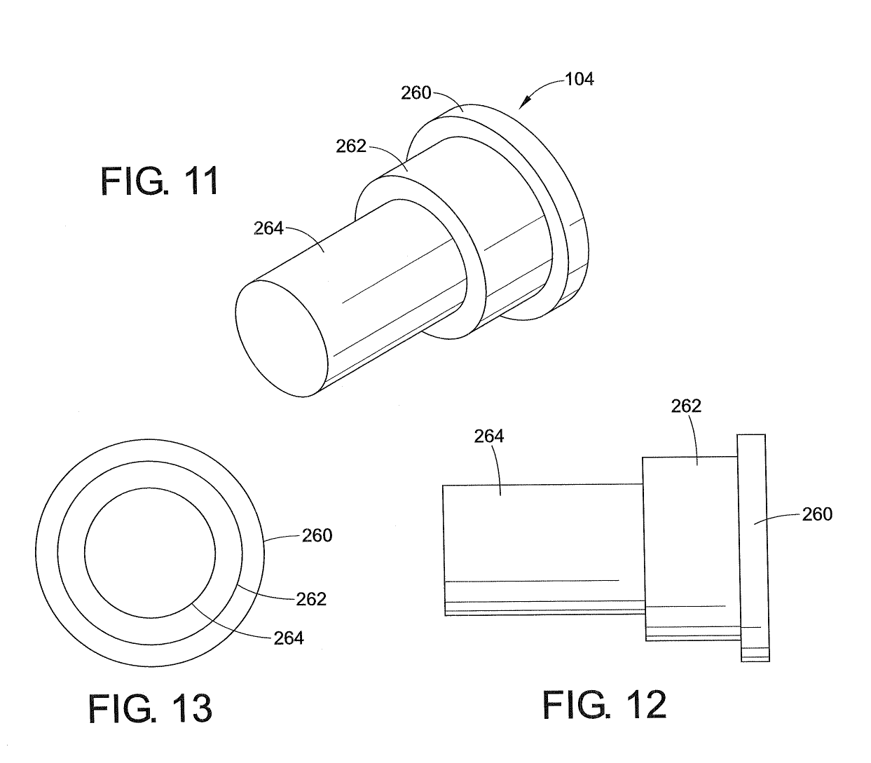

With reference now to FIGS. 11-13, the fastener 104 includes a head 260, an intermediate section 262 having a diameter smaller than a diameter of the head, and a shaft 264 having a diameter smaller than the diameter of the intermediate section. The head 260 is dimensioned to be at least partially received in the counterbore 182 provided in the tab 170. The head 260 has a width larger than a depth of the counterbore 182 such that a section of the head extends outwardly from the front surface 152 of the link body 150. The intermediate section 262 is dimensioned to be received through the first opening 180 provided in tab 170 and the opening 220 provided in tab 174. The shaft 264 is dimensioned to be received through the second opening 184 provided in tab 172. A second fastener 270 (FIGS. 2-4) can be secured to an end of the shaft 264 to prevent the fastener 104 from falling out of the openings 180, 184, 220 provided in the respective tabs 170, 172, 174. The second fastener 270 is configured to be at least partially received in the countersink 186. Once secured to the fastener 104, a portion of the second fastener 270 extends outwardly from the rear surface 154 of the link body 150. It should be appreciated that because the fasteners 104,270 extend slightly outwardly from the links 102, the links 102 can be protected against impacts. According to another exemplary aspect, the link 102 can be configured such that the fasteners 104,270 are generally flush with the front and rear surfaces 152,154 of the link body.

It should be appreciated that a resilient member, e.g., in the form of elastomeric O-ring, can be provided between the head 960 and the counterbore 182 of tab 170. The resilient O-ring can be compressively forced into the counterbore 182 with the O-ring in compressive contact with the link body 150. The O-ring can provide an effective seal to prevent fluids or other contaminants from entering between the interconnected links 102 of the saw chain 100, particularly, the connection between tab 174 of one link and tabs 170, 172 of an adjacent link.

With reference again to FIGS. 1-4, the cutting block 120 is fixed attached to the top wall 156 of the link body 150 in a known manner, such as by laser welding. The cutting block 120 includes a generally planer top surface 270, side surfaces 272, 274, and a bottom surface 276. The cutting block 120 has a width approximately equal to a width of the top wall 156 such that the bottom surface 276 extends across approximately the entire width of the top wall 156. A length of cutting block 120 is slightly shorter than a length of the top wall 156. Thus, the cutting block 120 provides a continuous base thereby maximizing a weld area between the cutting block and the link 102. An upper portion of each side surface 272,274 is inwardly inclined toward the upper surface 270. This incline can be in the range of about 30 degrees to about 55 degrees, and in the depicted embodiment, the incline is about 45 degrees. As shown, the upper surface 270 has a length which is about 50% to 75% of the length of the bottom surface 276. This provides for a generally trapezoidal shaped cutting block 120. This shape of the cutting block 120 (specifically the shape of the side surfaces) also provides for deflection of impact on a leading edge of the cutting block 120.

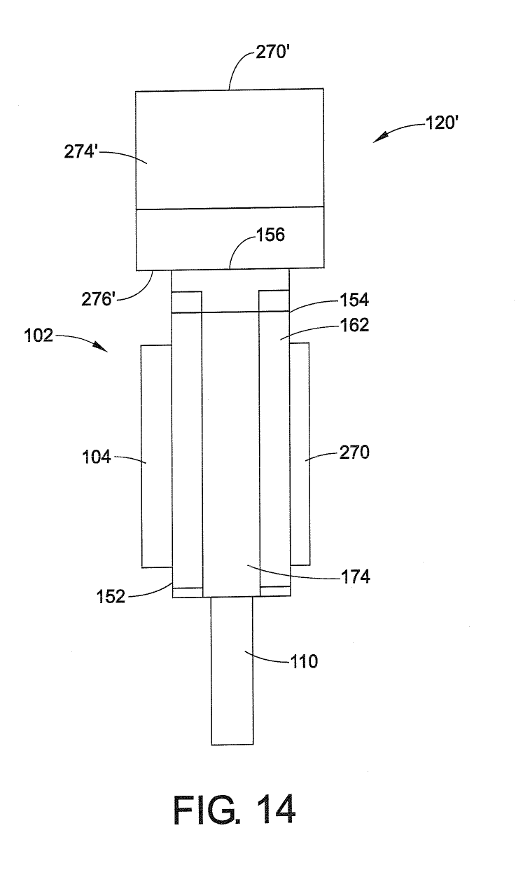

FIG. 14 illustrates a cutting block 120′ according to another exemplary aspect of the present disclosure. Similar to cutting block 120, the cutting block 120′ includes a generally planer top surface 270′, side surfaces (only side surface 274′ is shown), and a bottom surface 276′. The cutting block 120′ is sized to be larger than the width of the top surface 156 of the link body, and more particularly, the cutting block 120′ extends outwardly slightly past the fasteners 104,270. This at least partially protects the fasteners from damage during use of the saw chain 100. The cutting block 120,120′ can be made of a suitable carbide or whether hardened wear part material. Materials include cemented carbides. Examples of hardened wear part materials, which can be implemented alone or in combination, include tungsten carbide, titanium carbide, tantalum carbide, chromium carbide and silicon carbide. Other hard facing materials may be suitable for use for the cutting block 120, 120′.

With the construction of the plurality of links 102 of the saw chain 100 described above, the saw chain 100 has fewer links than a conventional saw chain. By providing identically shaped links 102 and interconnecting ends of those links with fasteners 104, the saw chain 100 has fewer fasteners than the known saw chains. Particularly, the exemplary saw chain 100 includes approximately one-half the number of fasteners, approximately 60% less parts than known saw chains for cutting aggregate materials. This also provides a saw chain 100 having less stretch (approximately one-half the stretch compared to the known saw chains) and less wear than the known saw chain. Further, the exemplary saw chain 100 is also provided without bumpers. It is known to provide bumpers on the drive links of the conventional saw chain to reduce concentration of force upon the cutters as the cutters saw down within a saw curve. With the trapezoidal segment design provided by the saw chain 100, the saw chain can run without the use of these known bumpers, which allows use of the entire cutting block 120.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A saw chain for cutting aggregate materials comprising:
a plurality of identically shaped interconnected links, each link having a first end and a second end, the first and second ends configured such that a first end of one link is connected to a second end of an adjacent link of the saw chain, the first end of each link including spaced apart first tabs and the second end of each link including a second tab, wherein to interconnect the plurality of links of the saw chain the second tab of each link is pivotally received between the first tabs of an adjacent link;
a plurality of cutting blocks mounted on alternating links along a length of the saw chain for engaging and eroding away the aggregate materials; and
a plurality of fasteners for interconnecting the plurality of links, the fasteners defining pivotal axes of the saw chain.

2. The saw chain of claim 1, wherein each link of the plurality of links includes a body having a front surface, a rear surface, a top surface, a bottom surface and identically shaped first and second side surfaces, and further including a tang depending downwardly from a central portion of the bottom surface.

3. The saw chain of claim 2, wherein the tang is equally spaced between the front and rear surfaces and is equally spaced between the first and second side surfaces.

4. The saw chain of claim 2, wherein the first tabs are identically shaped and extend outwardly from the first side surface and the second tab extends outwardly from the second side surface, the second tab having a shape identical to the shapes of the first tabs.

5. The saw chain of claim 2, further including:
a first opening extending through one of the first tabs and a second opening extending through the other first tab, the second opening being coaxial with the first opening and having a diameter smaller than a diameter of the first opening, and
a third opening extending through the second tab, the third opening having a diameter equal to the diameter of the first opening.

6. The saw chain of claim 5, wherein each of the first tabs includes an outer surface having an arcuate shape, and when the link is viewed from the front, the outer surface of the first tab having the first opening is generally concentric with the first opening, and when viewed from the rear, the outer surface of the first tab having the second opening is generally concentric with the second opening, and
wherein the second tab includes an outer surface having an arcuate shape, and when the link is viewed from one of the front or the rear, the outer surface of the second tab is generally concentric with the third opening.

7. The saw chain of claim 2, wherein an upper portion of each first tab and an upper portion of the second tab is spaced from the top surface of the link body, and a bottom portion of each first tab and a bottom portion of the second tab is contiguous with the bottom surface of the link body.

8. The saw chain of claim 2, wherein each of the first and second side surfaces are shaped to allow for pivotal movement of the plurality of links, the shape of each of the first and second side surfaces allowing the first tabs and second tab of interconnected adjacent links to extend at least partially into the link body.

9. The saw chain of claim 8, where each of the first and second side surfaces includes an inwardly extending arcuate section having a radius larger than a radius defined by a respective outer surface of each first tab and the second tab, the arcuate section of the first side surface being generally concentric with the outer surfaces of the first tabs, the arcuate section of the second side surface being generally concentric with the outer surface of the second tab, wherein the arcuate sections of the first and second side surfaces providing a clearance between the interconnected links.

10. The saw chain of claim 8, wherein each of the first and second side surfaces includes:
an upper section extending generally perpendicularly from the top surface toward respective upper portions of the first tabs and second tab, the upper sections of the plurality of links adapted to prevent outward flexing of the saw chain, and
a lower section extending at an obtuse angle relative to the bottom surface away from the bottom surface toward the arcuate section, the lower section providing for further pivotal movement of the interconnected links of the saw chain.

11. The saw chain of claim 1, wherein each cutting block includes a planer top surface, side surfaces, and a bottom surface, an upper portion of each side surface being inwardly inclined toward the upper surface, the upper surface having a length which is 50% to 75% of a length of the bottom surface.

12. The saw chain of claim 11, wherein a width of each cutting block is larger than a width of each link, the plurality of cutting blocks extending outwardly past the plurality of fasteners to at least partially protect the fasteners from damage during use of the saw chain.

13. The saw chain of claim 1, wherein the plurality of fasteners are configured to at least partially protect the plurality of links of the saw chain against impacts.

14. A saw chain for cutting aggregate materials comprising:
a plurality of identically shaped interconnected one-piece links, each link of the plurality of links including a body having a front surface, a rear surface, a top surface, a bottom surface and first and second side surfaces, a pair of spaced apart first tabs extend outwardly from the first surface and a second tab extends outwardly from the second surface, the first tabs and second tab are identically shaped and include an opening, each of the first tabs and the second tabs have an arcuate outer surface, wherein to interconnect the plurality of links of the saw chain, the second tab of each link is pivotally received between the first tabs of an adjacent link;
a plurality of cutting blocks mounted on the top surface of alternating links along a length of the saw chain for engaging and eroding away the aggregate materials; and
a plurality of fasteners extending through the openings of the first tabs and second tabs for interconnecting the plurality of links.

15. The saw chain of claim 14, wherein each link further includes a tang depending downwardly from the bottom surface, the tang being equally spaced between the front and rear surfaces and being equally spaced between the first and second side surfaces.

16. The saw chain of claim 14, wherein the first side surface is concaved toward the second side surface and the second side surface is concaved toward the first side surface, the shape of each of the first and second side surfaces allowing the first tabs and second tab of interconnected adjacent links to extend at least partially into the link body.

17. The saw chain of claim 16, where each of the first and second side surfaces includes:
an inwardly extending arcuate section, the arcuate section of the first side surface being generally concentric with the outer surfaces of the first tabs, the arcuate section of the second side surface being generally concentric with the outer surface of the second tab,
an upper section extending generally perpendicularly from the top surface toward respective upper portions of the first tabs and second tab, the upper sections of the plurality of links preventing outward flexing of the saw chain, and
a lower section extending at an obtuse angle relative to the bottom surface away from the bottom surface toward the arcuate section, the lower section providing for further pivotal movement of the interconnected links of the saw chain

18. The saw chain of claim 14, wherein each cutting block includes a planer top surface, side surfaces, and a bottom surface, an upper portion of each side surface being inwardly inclined toward the upper surface, the upper surface having a length which is 50% to 75% of a length of the bottom surface.

19. The saw chain of claim 14, wherein a first opening extending through one of the first tabs and a second opening extending through the other first tab, the second opening being coaxial with the first opening and having a diameter smaller than a diameter of the first opening, and a third opening extends through the second tab, the third opening having a diameter equal to the diameter of the first opening,
each fastener includes a head, an intermediate section having a diameter smaller than a diameter of the head, and a shaft having a diameter smaller than the diameter of the intermediate section, the intermediate section being dimensioned to be received through the first opening provided in one of the first tabs and the third opening provided in the second tab, the shaft being dimensioned to be received through the second opening provided in the other first tab, and
further including a second fastener configured to be secured to an end of the shaft to prevent the fastener from falling out of the openings provided in the respective first tabs and second tab.

20. The saw chain of claim 19, wherein the heads of the fasteners and the second fasteners project outwardly from the plurality of interconnected to at least partially protect the saw chain against impacts.
